(19) United States
(12) Patent Application Publication
(10) Pub. No.: US 2013/0209910 A1
(43) Pub. Date: Aug. 15, 2013

(54) EXPLOSION-PROTECTED FUEL CELL

(71) Applicants: Thomas Horn, Wolfsburg (DE); Ulrich Johannsmeyer, Vechelde (DE); Anton Schimmele, Kunzelsau (DE)

(72) Inventors: Thomas Horn, Wolfsburg (DE); Ulrich Johannsmeyer, Vechelde (DE); Anton Schimmele, Kunzelsau (DE)

(73) Assignees: BUNDESREPUBLIK DEUTSCHLAND VERTRETEN DURCH DAS BUNDESMINISTERIUM FUR WIRTSCHAFT UND TECHNOLOGIE, Braunschweig (DE); R. STAHL SCHALTGERATE GMBH, Waldenburg (DE)

(21) Appl. No.: 13/697,571

(22) PCT Filed: May 12, 2011
(86) PCT No.: PCT/EP11/57711

§ 371 Date: Jan. 29, 2013

(30) Foreign Application Priority Data
May 14, 2010 (DE) 10 2010 016 957.9

(51) Int. Cl. H01M 8/04

(52) U.S. Cl. CPC H01M 8/04029
USPC 429/436

(57) ABSTRACT

A fuel cell arrangement operable in environments that are prone to explosions including a fuel cell stack 14 that is housed in a containment vessel 15 filled with a heat equalizing fluid 26 and provided with a cooling system. The heat equalizing fluid 26 flows around all sides of the fuel cell stack 14 and prevents a direct concentrated heat transfer from the surface of the fuel cell stack 14 to the containment housing 15. The heat equalizing fluid 26 buffers and distributes local heat peaks originating from the fuel cell stack 14 and thus eliminates ignition sources.

### FIELD OF THE INVENTION

The invention relates to fuel cell arrangements for use in environments that are prone to explosions.

### BACKGROUND OF THE INVENTION

Fuel cells are known for generating electric energy by oxidizing a suitable fuel, i.e., a reducing agent, such as, for example, hydrogen with air or oxygen. Waste heat is generated during the normal operation of the fuel cell. The waste heat typically is generated on individual elements such as, for example, the electrodes of a proton-exchange membrane or on other elements. Cooling systems are frequently utilized for the dissipation of the waste heat.

Atypical operating modes and faults or damage of the fuel cell may cause a local temperature rise on the fuel cell that cannot be sufficiently suppressed by an industrial cooling system. For example, the fuel cell or parts thereof may heat up at locations that come in contact with the explosive ambient atmosphere. One particular problem with respect to explosion protection is that the local temperature rises may create hotspots on the outer surface of the fuel cell, the position of which is unpredictable.

Different fault scenarios within the fuel cell may cause such local temperature rises. If a degradation-related damage of a polymer electrolyte membrane occurs, for example, the safety function of the gas separation and electric insulation between the electrodes is neutralized. If this results in an internal gas transfer, i.e., an internal leak, a direct exothermal conversion, for example, of the hydrogen-air mixture being formed, results on the active layer of the electrode. Direct contact between the two oppositely arranged electrodes also cannot be precluded. This may result in local heating of the contact point due to increased current densities or transition resistances.

In addition, a cell voltage pole reversal, for example, due to a starting material depletion or overcurrents may lead to the respective cell in the stack not delivering, but rather consuming electric power such that the temperature of this cell can significantly increase. However, a local temperature rise of a fuel cell represents a potential ignition source if the fuel cell is used in an explosion-prone environment.

The utilization of fuel cells in explosion-prone environments is disclosed in DE 103 46 852 A1, wherein the fuel cell, as well as the corresponding hydrogen storage, is arranged within a containment. The containment is acted upon with an inert gas such as, for example, nitrogen or clean air in order to enclose the fuel cell contained therein and the hydrogen storage in a pressurized encapsulation. The fuel cell may be provided with a cooling device in order to transfer heat to the surroundings and, if applicable, to a hybrid hydrogen storage.

A pressurized encapsulation of a fuel cell can be used for keeping an explosion-prone atmosphere away from the fuel cell. However, a pressurized encapsulation can only be realized with a relatively high effort because it requires continuous thorough rinsing or the compensation of leakage losses at least in instances in which the containment is not hermetically tight. In the start-up phase, it is furthermore required to carry out multiple thorough rinsing processes in order to ensure that no explosive mixture is any longer in the containment before it is even permitted to electrically switch on the fuel cell. This requires complex monitoring and control devices that need to be protected, e.g., in a flameproof enclosure just like the shut-off device. In addition, clean air or inert gas is not available on-site in many applications and therefore needs to be supplied from outside the explosion-prone environment. This is not even possible in most mobile applications.

### OBJECTS AND SUMMARY OF THE INVENTION

It is an object of the present invention to provide a fuel cell arrangement that is adapted for more reliable and safe usage in explosion-prone environments. The inventive fuel cell arrangement comprises a fuel cell stack with at least one inlet for an oxidizing agent, at least one inlet for a reducing agent (i.e. fuel), at least one outlet for reaction products and/or residual gases, and at least two electric terminals. The fuel cell stack preferably comprises several individual fuel cells that are connected to the respective inlets and outlets via a corresponding distributor and connected to the electric terminals. The oxidizing agent consists, for example, of air or oxygen. The reducing agent consists of hydrogen or another fuel.

The inventive fuel cell arrangement is provided with a heat equalizing jacket that serves for equalizing the heat distribution on the outer surface that is in contact with the potentially explosive atmosphere and for thereby preventing hotspots. The heat equalizing jacket may be effected within the fuel cell stack in the form of an integral component thereof or alternatively in the form of an outer jacket thereof.

In a second variation, the inventive fuel cell arrangement comprises a containment housing that encloses the fuel cell stack and is filled with a heat equalizing fluid that surrounds the fuel cell stack on all sides, i.e., on six sides, in order to form the heat equalizing jacket. Consequently, a layer of heat equalizing fluid is arranged between the surface of the fuel cell stack and the containment housing in every direction. The layer thickness is preferably so large that the thermal capacity of the heat equalizing fluid volume present in the layer suffices for absorbing quantities of heat being released on the surface of the fuel cell stack in case of a fault within safe temperature limits. The heat equalizing fluid preferably consists of an electrically insulating fluid with high heat storage capacity. Water (e.g., pure water) or an aqueous solution may also be used. In the aforementioned context, a “high heat storage capacity” is considered to be a heat storage capacity that amounts to at least ⅓, preferably at least half the heat storage capacity of water. The heat equalizing fluid preferably is a fluid with low viscosity. “Low viscosity” refers to a viscosity value that is lower than twice the viscosity of water.

The heat equalizing fluid may also consist of a highly viscous fluid or a gel with high thermal conductivity that is able to quickly and uniformly distribute the temperature of hotspots of the fuel cell. However, the latter requires separation from the cooling circuit. In this context, a “high thermal conductivity” is considered to be such a high thermal conductivity that the heat originating from hotspots is distributed in such a way that no hazardous temperatures occur on the containment housing.

In the containment housing, the fuel cell stack is held at a distance from all walls of the containment housing. In this way, any local surface heating of the fuel cell stack is initially absorbed by the heat equalizing fluid and eliminated buffered. In any case, the quantity of heat occurring at the locally heated spot is not transferred to the containment housing in a concentrated fashion, but rather distributed over large surfaces thereof. The superficial heating of the containment housing therefore is significantly lower than the heating that occurs if the fuel cell stack and the containment housing are in direct contact, hotspots can thereby be prevented and no hazardous temperatures reached.

In order to hold the fuel cell stack in the containment housing such that it is spaced apart from the walls of the containment housing, it may be held and supported in the interior of the containment housing by means of individual elements that preferably have no or only a small thermal conductivity such as, for example, plastic webs, ceramic webs or even metallic webs or the like.

The inventive fuel cell arrangement further may feature at least one cooling duct through which a cooling medium flows. This cooling duct serves for the industrial cooling of the fuel cell stack and may be connected, for example, to an external cooler in order to establish a cooling circuit. The cooling fluid in the cooling duct may be the same fluid as the heat equalizing fluid. However, it is also possible to choose a different type of fluid.

The cooling circuit may extend separately of the heat equalizing fluid, wherein the cooling circuit is connected to the heat equalizing fluid in the interior of the containment housing in another region.

The heat equalizing fluid in the containment housing may be pressurized. In this case, the containment housing is sealed relative to the surroundings. It is also possible to provide a pressure relief opening on the containment housing in order to permit a pressure compensation between the surroundings and the interior of the containment housing. A flame trap also may be arranged in the pressure relief opening.

With the arrangement of the fuel cell stack within a heat equalizing medium that surrounds the fuel cell stack on all sides makes it possible to permit integrative temperature monitoring. For example, a temperature sensor may be provided for measuring the temperature of the heat equalizing fluid and connected to an evaluation device. If local hotspots occur on the surface of the fuel cell, the associated heating of the heat equalizing fluid can be evaluated as a fault signal and used for initiating an emergency shutdown sequence. During the course of the emergency shutdown sequence, for example, the electric load can be separated from the fuel cell and/or the process gas supply can be closed, preferably after the separation of the electric load.

The waste gas temperature of the fuel cell stack may be additionally or alternatively monitored. A shutdown sequence can be initiated when a temperature limit is exceeded.

It is furthermore possible to convey the reaction products or residual gases through a cooling spiral before they leave the fuel cell arrangement. The cooling spiral may be arranged, for example, in the heat equalizing fluid. Alternatively, it may be connected to the cooling circuit.

Other objects and advantages of the invention will become apparent upon reading the following detailed description and upon reference to the drawings.

### BRIEF DESCRIPTION OF THE DRAWINGS

FIG. 1 is a diagrammatic depiction of a fuel cell arrangement with a fluid filled containment in accordance with the invention;

FIGS. 2-4 are diagrammatic depictions of alternative embodiments of fuel cell arrangements in accordance with the invention; and

FIG. 5 is a diagrammatic depiction of a fuel cell arrangement in accordance with the invention arranged with alternative modular compliments.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE PREFERRED EMBODIMENTS

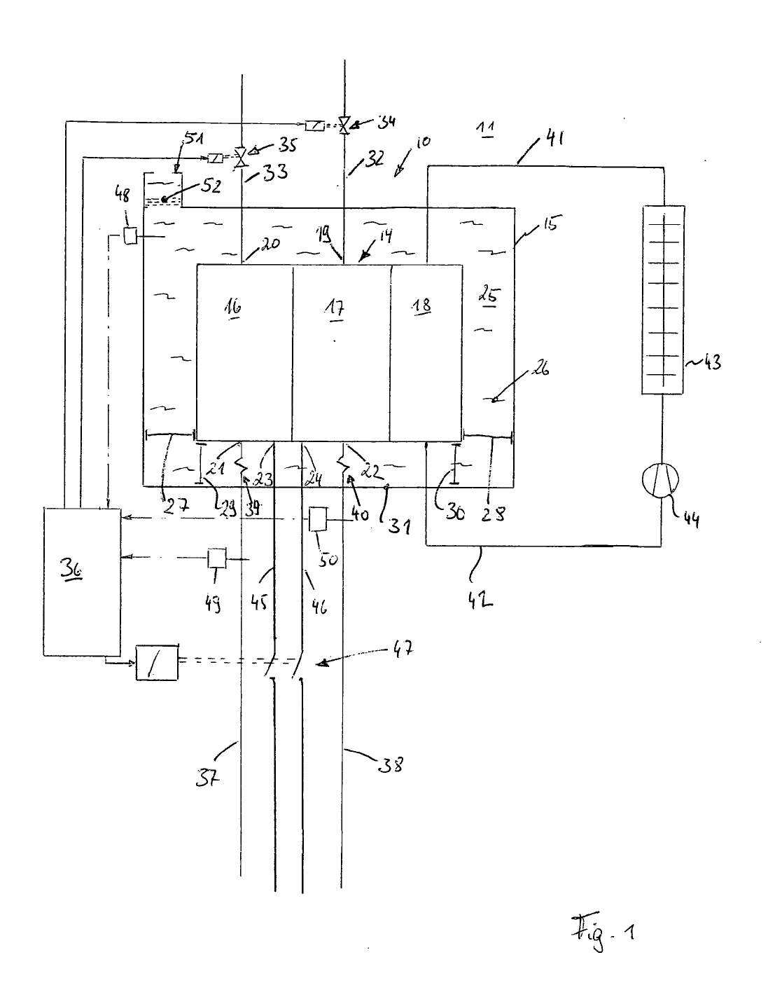

Referring more particularly to FIG. 1 of the drawings, there is shown an illustrative fuel cell arrangement 10 in accordance with the invention arranged in an explosion-prone environment 11. The fuel cell arrangement 10 forms part of a system that is constructed in an explosion-proof fashion and which additionally comprises other components such as coolers and fans, compressors, an accumulator, sensors and actuators, as well as a control, all of which are preferably also arranged in an explosion-proof fashion.

The centerpiece of the fuel cell arrangement 10 is a fuel cell stack 14 and a containment housing 15 that encloses this fuel cell stack on at least five sides. The fuel cell stack 14 comprises several fuel cells, preferably many individual fuel cells, that are combined into what is commonly referred to as a “stack”. Each individual fuel cell comprises an anode, a cathode, a solid or liquid electrolyte arranged in between or, for example, a proton-exchange membrane, as well as gas supply and discharge means with corresponding fluid ducts. In addition, cooling elements may respectively form part of one or more fuel cells. The individual fuel cell elements are combined into a stack by means of appropriate fluid distributors, as would be understood by a person skilled in the art. In FIG. 1, an anode block 16 symbolizes all anodes, a cathode block 17 symbolizes all cathodes and a cooling block 18 symbolizes all cooling elements. However, it will be understood that the individual anodes, the cathodes and the cooling elements are arranged alternately in the stack.

The fuel cell stack 14 forms, for example, a cuboid structure or a differently shaped structure such as, for example, a cylindrical structure. Connections are arranged at suitable locations. These connections include at least one inlet 19 for an oxidizing agent such as, for example, air or oxygen, an inlet 20 for a reducing agent (i.e., fuel) such as, for example, methanol, methanol vapor, hydrogen or the like, at least one outlet 21, 22 for products and/or residual (anode) gases, as well as at least one electric terminal 23 and another electric terminal 24. Alternatively, one of the terminals 23, 24 may be formed by the housing of the fuel cell stack 14 itself.

The containment housing 15 encloses an interior 25 in which the fuel cell stack 14 is arranged such that it does not contact the surface of the containment housing 15. The interior 25 is filled with a heat equalizing fluid 26 that surrounds the fuel cell stack 14 on all sides, i.e., on six sides. Consequently, the surface of the fuel cell stack 14 is in contact with the heat equalizing fluid 26 on all sides. The heat equalizing fluid may consist, for example, of water, preferably water that is free of minerals, or of another low-viscosity fluid that preferably is not electrically conductive and has a high heat capacity.

However, it would also be possible to utilize a gel with high thermal conductivity for the heat equalization on the fuel cell stack, wherein the gel is able to quickly and uniformly distribute the temperature of hotspots of the fuel cell. However, the latter requires separation from the cooling circuit.

The fuel cell stack 14 is held in the interior 25 such that it is spaced apart from all walls of the containment housing 15, particularly also from its bottom wall 31, with the aid of suitable holders 27, 28, 29, 30. The holders 27 to 30 may consist of plastic, ceramic or even a metal. The holders preferably have no significant heat conduction, namely either due to their material selection or due to constructive measures. In addition, they are preferably arranged on the fuel cell stack 14 at locations at which no local hotspots are expected.

Instead of utilizing holders 27 to 30, the inner sides of the containment housing 15 may be provided with corresponding projections on which the fuel cell stack 14 is supported in a punctiform fashion or with a small supporting surface. The holders 27 to 30 may also be in the form of elements of the fuel cell stack 14.

The connections 19, 20 are connected to lines 32, 33 leading out of the containment housing 15. In the exemplary embodiments described herein, optional valves 34, 35 may be provided in the lines 32, 33 in order to shut off the supply of the oxidizing agent and/or the reducing agent, if so required. The valves 34, 35 may be controlled by a monitoring unit 36.

The outlets 21, 22 are connected to lines 37, 38 that convey the reaction products and/or residual gases being created out of the containment housing 15. If so required, the line 37, as well as the line 38, may extend through a corresponding cooling device such as, for example, a cooling spiral 39, 40. The cooling spiral 39, 40 may be arranged in the interior 25 of the containment housing in order to be in contact with and cooled by the heat equalizing fluid 26. Alternatively, other cooling devices for the mediums flowing in the lines 37, 38 may also be provided inside and/or outside the containment housing 15.

The fuel cell stack 14 is preferably provided with a cooling system, the cooling block 18 of which is illustrated in FIG. 1. This cooling block may be connected to a cooler 43 via a flow pipe 41 and a return pipe 42. In addition, a circulating pump 44 may be arranged in such cooling circuit. The cooling circuit is preferably closed, i.e., the cooling fluid flowing in this cooling circuit being separated from the heat equalizing medium 26. The cooling fluid may consist of water, oil or the like.

The electric terminals 23, 24 of the fuel cell stack 14 are connected to electric lines 45, 46 that lead out of the containment housing 15. The lines 45, 46 may be optionally connected to an electric switch 47 that makes it possible to interrupt the current flow in the lines 45, 46. The switch 47 may be controlled, for example, by the monitoring unit 36. The switch 47 is optional in this exemplary embodiment, as well as the exemplary embodiments described below. It may be arranged inside or outside the containment housing 15.

The monitoring unit 36 may be connected to temperature sensors such as, for example, a temperature sensor 48 for measuring the temperature of the heat equalizing fluid 26. One or more other temperature sensors 49, 50 may be provided on the lines 37, 38, for example, in order to monitor the waste gas temperature of the fuel cell stack 14. The temperature sensors 49, 50 may be arranged inside or outside the containment housing 15. They may be arranged upstream or downstream of the cooling spirals 39, 40 relation to the flow direction of the fluid.

The containment housing 14 may be provided with a pressure relief opening 51 that is preferably arranged on its upper side. If required, a flame trap 52 may be arranged in this pressure relief opening. This flame trap may be arranged above or underneath the fluid level of the heat equalizing fluid 26. The containment housing 15 alternatively may be open on its upper side.

The fuel cell arrangement 10 described above as follows:

During operation, an oxidizing agent and a reducing agent are conveyed into the fuel cell stack 14 through the lines 32, 33 while the valves 34, 35 are open. When the switch 47 is closed, the generated current flows through the lines 45, 46 in order to supply a load that is not illustrated in greater detail. The produced product stream leaves the fuel cell stack via the lines 37, 38. The evaluation device 36 monitors the temperatures of the heat equalizing fluid 26 and of the product stream. In addition, the circulating pump 44 continuously conveys a cooling medium through the cooling ducts that are symbolized by the cooling block 18.

During proper operation, the cooling system safely dissipates the lost heat of the fuel cell stack 14 via the cooler 43. However, if a fault scenario occurs that leads to a local heat development on the fuel cell stack 14, this locally developed heat cannot be dissipated with absolute certainty by the cooling circuit alone in all instances. This is the reason why a heat flow out of the fuel cell stack 14 may occur and cause local heating on the surface of the fuel cell stack. At this location, the heat flow transfers into the heat equalizing fluid 26 and is absorbed and distributed thereby. The heat equalizing fluid surrounds the fuel cell stack 14 and prevents direct contact of heat with the explosive atmosphere of the surroundings 11. In addition, the heat equalizing fluid 26 prevents possible hotspots on the surface of the fuel cell stack 14 from directly affecting the temperature distribution on the surface of the containment housing 15. Convection processes make it possible to practically realize a homogenous temperature distribution in the entire volume of the containment housing 15. Due to its heat capacity, the heat equalizing fluid represents a thermal buffer. Consequently, the heat flow originating from the fuel cell stack 14 cannot abruptly change the temperature of the containment housing 15. Furthermore, the enclosure of the fuel cell stack 14 by the heat equalizing fluid in connection with the surface of the containment housing 14 that is larger than that of the fuel cell stack 14 provides an additional cooling effect.

If the evaluation device 36 detects that the heat equalizing fluid 26 is heated above a given limiting value, it can close the valves 34, 35 and/or open the switch 47 i.e. load shedding. An orderly shutdown sequence can thereby be carried out. This may likewise take place if the monitoring device 36 detects an excessively high waste gas temperature with the aid of the temperature sensors 49, 50.

The fuel cell arrangement 10 described above may be subject to numerous modifications described in an exemplary fashion below. The preceding description respectively applies in this respect and the same reference symbols are used in the following description.

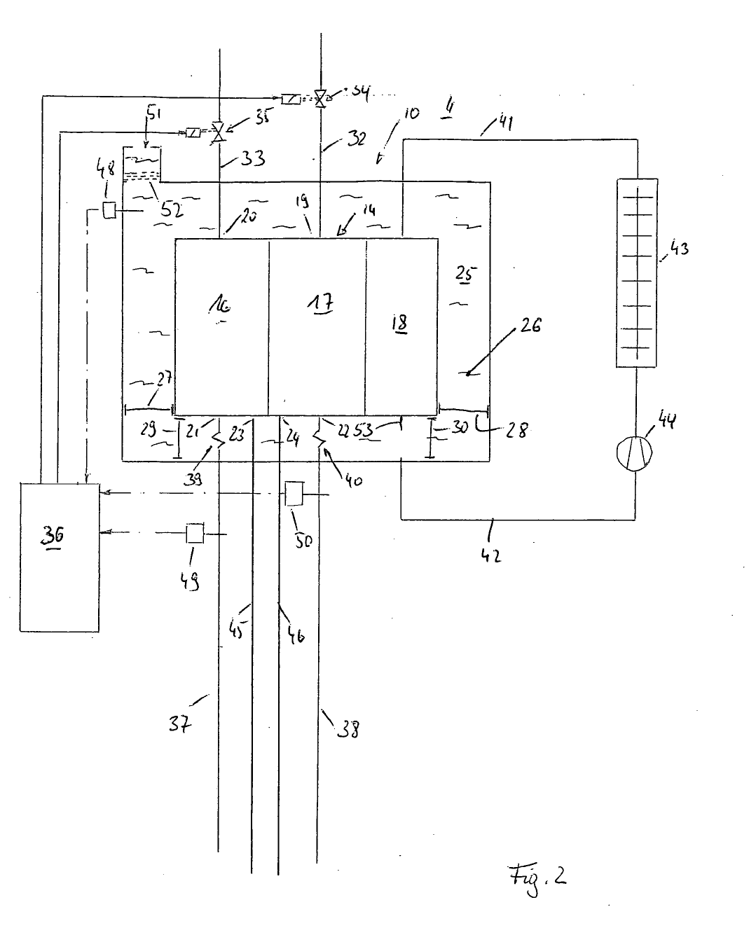

As depicted in FIG. 2, the switch 47 can be eliminated in each of the embodiments described above or below. It is likewise possible to eliminate the valves 34, 35. If the monitoring device 36 detects a fault scenario in this case, a fault signal can be generated and forwarded to other system components such as, for example, the connected load or the connected fuel source in order to effect the respective deactivation thereof.

In each of the embodiments described above and below, the heat equalizing system formed by the heat equalizing fluid 26 may also be connected to the cooling system that is formed by the cooling block 18, the flow pipe 41, the return pipe 42 and, if applicable, the cooler 43 and the circulating pump 44. The coupling of the two systems may be effected, for example, by connecting the return pipe 42 to the containment housing 15 and to its interior 25. The inlet 53 of the cooling block 18 in the interior 25 may be open in this case. The cooling fluid and the heat equalizing fluid are identical in this example. The cooling medium initially flows into the interior 25 via the flow pipe 42 and then from the interior back to the cooler 43 via the cooling block 18 and the flow pipe 41. The connection may alternatively also be produced in identical fashion on the flow pipe 41.

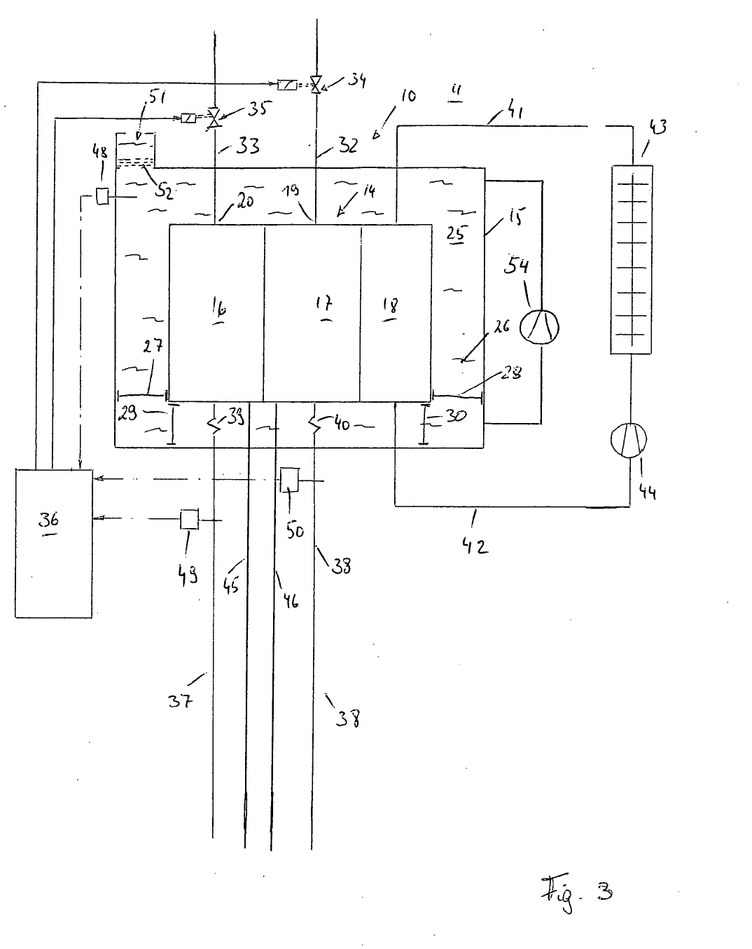

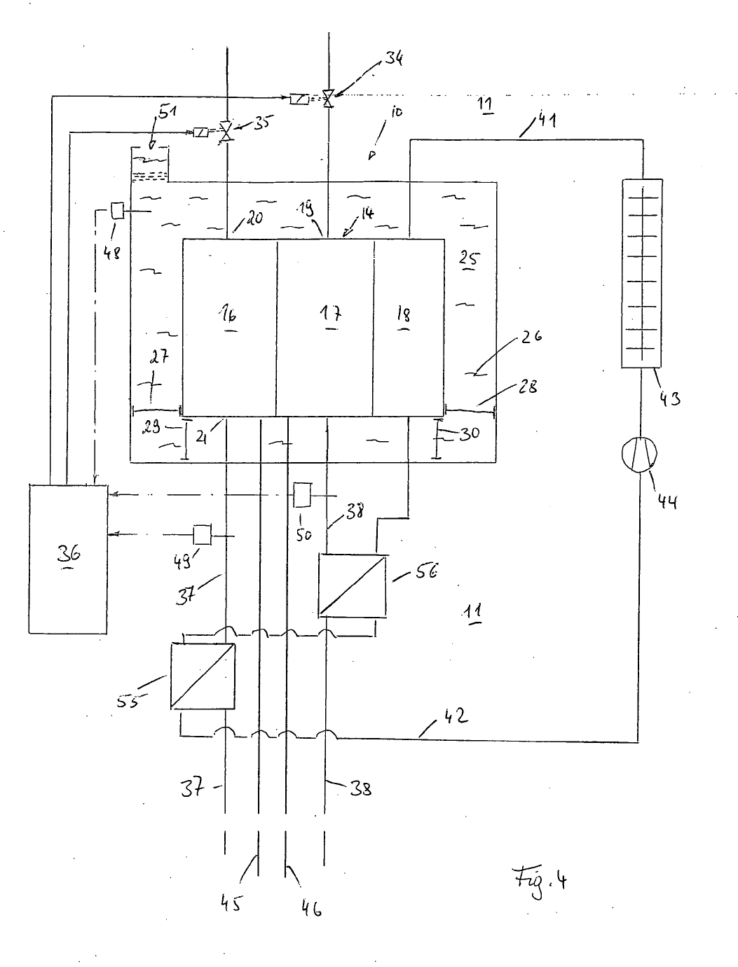

According to the embodiment of FIG. 3, additional means for increasing the flow within the heat equalizing fluid 26 may be provided in each of the embodiments described above and below, for example, in the form of a circulating pump 54 that may be arranged inside or outside the containment housing 15.

Another modification that can be used in each of the above-described embodiments concerns the cooling of the products given off by the fuel cell stack 14. The cooling may be entirely eliminated. However, it is also possible to arrange heat exchangers in the at least one line 37 and/or 38 as shown. These heat exchangers may be in contact with and cooled by the air of the surroundings 11. It is also possible to provide heat exchangers 55, 56 that are cooled, for example, by the cooling medium of the cooling circuit. They may be arranged in parallel or in series in the return pipe 42 or also in the flow pipe 41. In addition, they may be cooled by means of a separate cooling circuit in order to dissipate the heat from the product stream of the lines 37 and/or 38.

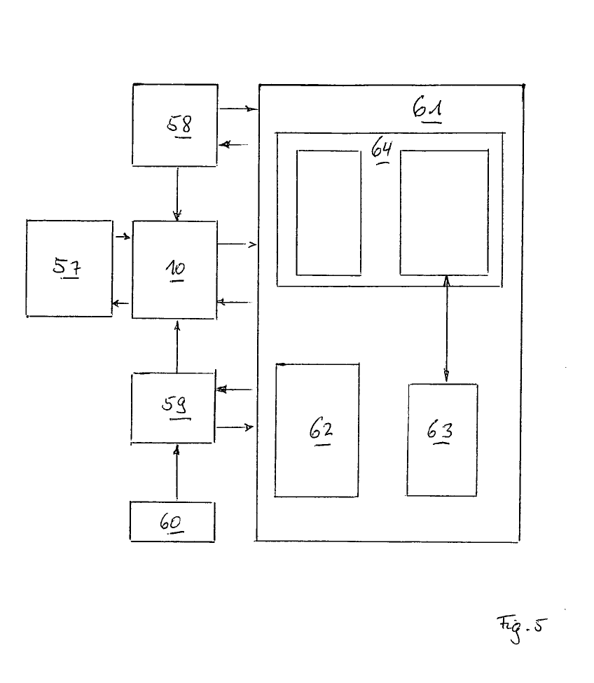

FIG. 5 shows the entire fuel cell system in the form of a block diagram. According to this embodiment, the fuel cell arrangement 10 forms part of a complete system that is effected in an explosion-proof fashion. The complete system may include the following components: a cooling module 57 such as, e.g., the above-described cooler 43 and pump 44, an air supply module 58, a fuel supply module 59, a fuel storage 60 (e.g., hydrogen storage) and a control module 61. The latter may comprise a control unit 62 (e.g., a SPS), an accumulator 63 and an energy management module 64. The energy management module 64 may contain several components such as, e.g., a DC/AC converter and a component that monitors and regulates the energy distribution. The containment housing 15 may contain, e.g., only the fuel cell arrangement 10 or alternatively also other modules such as, e.g., the air supply module 58, the fuel supply module 59, the fuel storage 60 and/or the entire control module 61 or parts thereof.

From the foregoing, it can be seen that a fuel cell arrangement is provided that is adapted for safer and more reliable usage in explosion prone environments. A fuel cell stack 14 is provided with a cooling system in a containment housing 15 that is filled with a heat equalizing fluid 26. The heat equalizing fluid 26 flows around all sides of the fuel cell stack 14 and prevents a direct concentrated heat transfer from the surface of the fuel cell stack 14 to the containment housing 15. The heat equalizing fluid 26 buffers and distributes local heat peaks originating from the fuel cell stack 14 and therefore eliminates ignition sources.

It will be understood that the use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e. meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

A preferred embodiment of this invention is described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Moreover, any combination of the above-described elements in all possible variations thereof is encompassed by the invention unless otherwise indicated herein or otherwise clearly contradicted by context.

1-15. (canceled)

16. An explosion-proof fuel cell arrangement (10) comprising a fuel cell stack (14) having at least one inlet (19) for an oxidizing agent, at least one inlet (20) for a reducing agent, at least one outlet (21) for reaction products and/or residual gases, and at least two electric terminals (23, 24), and
a heat equalizing jacket (15, 25, 26) that encloses the fuel cell stack (14).

17. The fuel cell arrangement according to claim 16 in which said heat equalizing jacket includes a containment housing (15) that encloses the fuel cell stack (14), and a heat equalizing fluid with and interior (25) of the containment housing (15) in surrounding relation to all sides of the fuel stack (14).

18. The fuel cell arrangement according to claim 17 in which said heat equalizing fluid (26) is a substance with high heat storage capacity.

19. The fuel cell arrangement according to claim 17 in which said heat equalizing fluid (26) is a gel with high thermal conductivity.

20. The fuel cell arrangement according to claim 16 in which said fuel cell stack 14 has at least one cooling duct (18) through which a cooling medium flows.

21. The fuel cell arrangement according to claim 20 in which said cooling duct 18 is connected to an external cooler (43).

22. The fuel cell arrangement according to claim 17 in which said cooling duct 18 is separated from an interior (25) of the heat equalizing jacket.

23. The fuel cell arrangement according to claim 20 in which said cooling duct (18) is connected to an interior (25) of the heat equalizing jacket.

24. The fuel cell arrangement according to claim 17 in which the heat equalizing fluid (26) is pressurized.

25. The fuel cell arrangement according to claim 17 in which the heat equalizing fluid (26) is in contact with ambient air.

26. The fuel cell arrangement according to claim 17 in which said containment housing (15) is connected to a circulating pump for the heat equalizing fluid (26).

27. The fuel cell arrangement according to claim 17 including a temperature sensor (48) for measuring the temperature of the heat equalizing fluid (26), and a monitoring unit (36) to which the temperature sensor is connected.

28. The fuel cell arrangement according to claim 16, including a temperature sensor (49) provided for measuring the temperature of reaction products and/or residual gasses, and a monitor (36) to which said temperature sensor (49) is connected.

29. The fuel cell arrangement according to claim 27 in which said monitoring unit (36) is connected to an electric separating device (47) that is connected to at least one electric terminal (23, 24) of the fuel stack.

30. The fuel cell arrangement according to claim 28 in which said monitoring unit (36) is connected to an electric separating device (47) that is connected to at least one electric terminal (23, 24) of the fuel stack.

31. The fuel cell arrangement according to claim 16 in which said monitoring unit (36) is connected to a fluid shut off device (34, 35) that is connected to the inlet (32) of the oxidizing agent that is connected to one of the inlet (32) of the oxidizing agent or the inlet (20) of the reducing agent.

32. The fuel cell arrangement according to claim 16 in which said outlet (21) for reaction products and/or residual gasses is connected to a cooling device (39, 55).
